(19) United States
(12) Patent Application Publication
(10) Pub. No.: US 2002/0162077 A1
(43) Pub. Date: Oct. 31, 2002

(54) In-sync hierarchy browser which provides version and access control on design collaboration for chip designs

(76) Inventors: Chau-Iou Jeng, Fremont, CA (US); Alice Wang, Burnaby (CA); Roger Chen, San Jose, CA (US); Russell Ho, Belmont, CA (US)

Correspondence Address: SAWYER LAW GROUP LLP, P.O. Box 51418, Palo Alto, CA, 94303, US

(21) Appl. No.: 09/846,496

(22) Filed: Apr. 30, 2001

(51) Int. Cl. G06F 17/50

(52) U.S. Cl. 716/1

(57) ABSTRACT

An integrated circuit chip design system for a design hierarchy is disclosed. The chip design is provided by a plurality of design blocks. The system comprises version and access control which controls the design hierarchy. The system further includes an in-synchronization hierarchy display responsive to the version and access control which illustrates the design hierarchy based upon an ownership of the plurality of design blocks within the hierarchy. A system and method in accordance with the present invention can help designers to control the design process, can automatically highlight design dependency change, and can minimize human mistakes.

### FIELD OF THE INVENTION

The present invention relates generally to designing integrated circuit chips and specifically to providing a system for controlling the design of an integrated circuit chip.

### BACKGROUND OF THE INVENTION

As silicon technology provides higher submicron processing depths, chip design complexity containing tens of millions of gate counts is dramatically increasing. Handling design data management in chip designs is much more difficult as a result. However, the decreasing time-to-market design cycle puts extremely higher pressure on integrated circuit (IC) designers. Accordingly, it is important to provide efficient design data management with design synchronization capabilities. To achieve design synchronization, the entire design process must be managed effectively.

Design hierarchy plays an important role for the chip design in semiconductor industry. Project managers usually need to maintain the design hierarchy, and then assign sub-blocks to team members for implementation. Next, design integration engineers will assemble a plurality of sub-blocks at the chip level for final verification.

If any bugs are found during implementation or integration, the design system should reflect impact based upon design dependency for any necessary refinement. FIG. 1 illustrates a representation of chip design hierarchy 10. The design hierarchy includes a top level control 12. The top level control 12 manages design block A14, B16 and C18. In this design block A14 also controls design sub-block D20 and E22. In the design hierarchy 10, blocks that are managed by other blocks provide information about problems to their parent blocks. For example, if a bug is identified in block D in FIG. 1, the design system should alert project managers who can take action items on blocks A14 and the top level control 12.

Since chip designs are typically complicated and have many entities involved in the design hierarchy, version control for each block in the hierarchy is required to completely control development modification between blocks. In addition, the ownership for each block must be assigned to set up appropriate access permission. For example, block A14 ownership in USA, block B16 ownership may be in Japan, block C18 ownership may be in Germany, and final integration on chip-level may be in USA. The owner of block A14 cannot access blocks B16nd C18. Only the project manager at the top level control 12 can access and view all the blocks. Therefore, ownership assignment must be combined with access control and version control.

There are several commercial tools for version control and access control. However, they are generics for any application and they work only on a single development site. Accordingly if a block from one company is incompatible with the block from another company, the information can not be adequately managed by the top level. Accordingly, what is needed is a system and method for designing integrated circuit chips and specifically to provide a system for controlling the design of an integrated circuit chip. The present invention addresses such a need.

### SUMMARY OF THE INVENTION

An integrated circuit chip design system for a design hierarchy is disclosed. The chip design is provided by a plurality of design blocks. The system comprises version and access control which controls the design hierarchy. The system further includes an in-synchronization hierarchy display responsive to the version and access control which illustrates the design hierarchy based upon an ownership of the plurality of design blocks within the hierarchy.

A system and method in accordance with the present invention can help designers to control the design process, can automatically highlight design dependency change, and can minimize human mistakes.

### BRIEF DESCRIPTION OF THE DRAWINGS

FIG. 1 illustrates a representation of chip design hierarchy.

FIG. 2 depicts a chip design hierarchy browser with version control. In this figure, all the versions of the highlighted block on the left-hand side will be shown on the right-hand side.

FIG. 3 illustrates a chip design hierarchy browser with access control. In this figure, all the permission-granted members of the highlighted block on the left-hand side will be shown on the right-hand side.

FIG. 4 depicts the workflow of an in-sync display where there are multiple groups on multiple sites.

FIG. 5 illustrates an embodiment of a version and access control in accordance with the present invention.

FIG. 6 describes the content of in-sync hierarchy display.

### DETAILED DESCRIPTION

The present invention relates generally to designing integrated circuit chips and specifically to providing a system for controlling the design of an integrated circuit chip. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention provides real-time design synchronization status of various blocks within a design in conjunction with design hierarchy. The status includes all the versions of all of the blocks of a design. The status also provides any incremental design change, and accommodates the design data dependency across the design hierarchy. In addition, all the activities can be synchronized in a single site, multiple groups of single site, and multiple groups of multiple sites.

The key features of the present invention offer design collaboration utilizing design synchronization, design visibility, design data management, and design process management. Design synchronization is one of keys in the entire design process, particularly blocks are controlled by different entities. The present invention provides a visual environment that displays the design hierarchy while providing the status of version control and access control for the different entities. across data discrepancies, geographical boundaries, and time zones.

Accordingly, a chip design can be modified in accordance with different blocks. The other main advantage of the present invention is design synchronization on co-development for various geographical design centers. Since design collaboration across various design centers is important, a Java-based web-enabled design environment is the perfect candidate to cross the platform barriers and geographical boundaries. The in-sync hierarchy browser in accordance with the present invention will allow chip designers to view their design hierarchies utilizing a web browser. To illustrate the features of the present invention in more detail, refer now to the description following, in conjunction with the accompanying drawings.

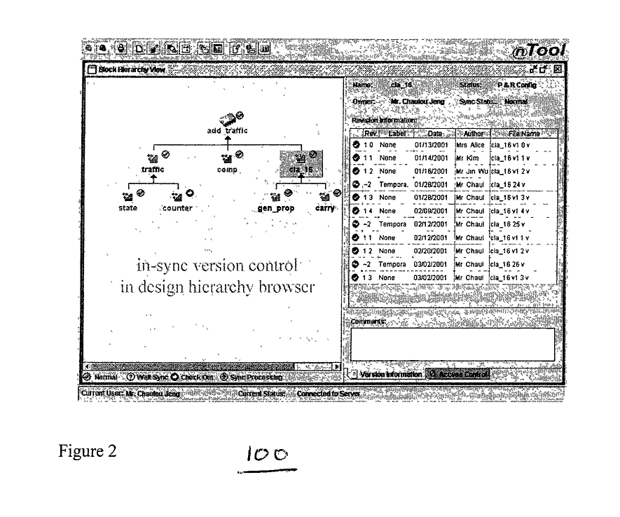

FIG. 2 depicts a chip design hierarchy browser 100 with version control in accordance with the present invention. The browser 100 depicts end of blocks and their relationship with each other. To the right side of the hierarchy 102 is listing of the version for a team member that has permission granted.

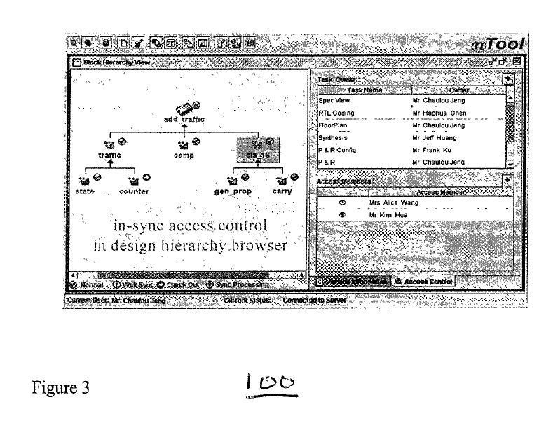

FIG. 3 illustrates the chip design hierarchy browser 100 with access control. Inside the design hierarchy browser 100, users can view all the statuses that include ownership, design dependency, and project snapshot. The design hierarchy can be used at any level (i.e., system, cell, view, and flow). System is the top or chip level design. The cell is any block inside the system. View can be, for example, any EDA (Electronic Design Automation) tool library. Typically views include simulation, synthesis, and place-and-route. For example, if the foundry supports Avanti's place-and-route, it will provide the Apollo view for the user community. (Apollo is a place-and-route tool from Avanti.) Flow will be embedded inside the design hierarchy along with tool scripts. The task of the hierarchy is to perform access and version control in the design hierarchy. Then all the statuses can be made visible on a network.

In a preferred embodiment, access and version control is performed on the design hierarchy inside the web browser. Typically, the version and access control will be synchronized on multiple sites.

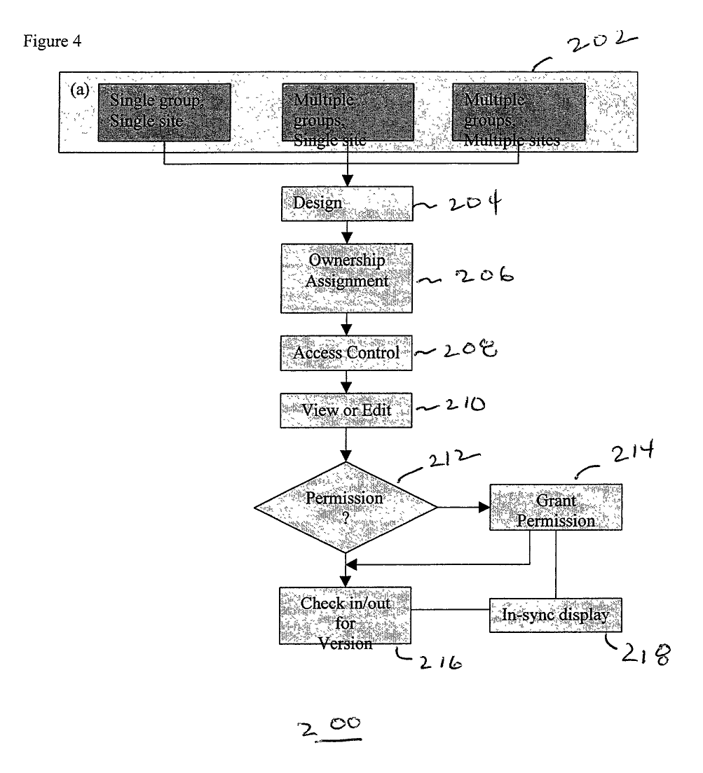

Accordingly, a system and method in accordance with the present invention can be implemented with a single group of blocks on a single site, with multiple groups of blockson a single site, and with multiple groups on multiple sites. FIG. 4 depicts the workflow of an in-sync hierarchy system 200 where there are multiple groups of blocks on multiple sites. It illustrates the procedure from ownership assignment to access control and version control on a particular block.

First, the resources are allocated, via step 202. Next, a project manager can partition the design based upon the design specification, via step 204. Then, the project managers can assign the ownership on each block inside the design hierarchy.

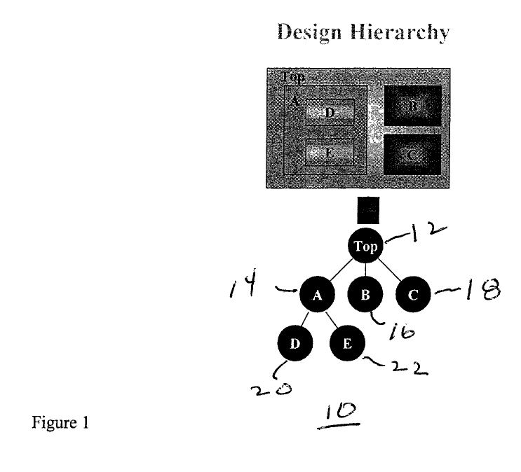

The project manager can then assign ownership on the design blocks at the chip level, via step 206. Each block is another sub-design hierarchy. Next, appropriate access control is provided, via step 208. Next, view and edit control is provided, via step 212. Only the appropriate project manager can access each block or sub-block. Only the specific block owner can access that block and all the sub-blocks below that block. For example, as discussed before with respect to FIG. 1, the owner of block A12 cannot access the block B14 unless the project manager or the owner of block B12 grants the permission.

The block owner is the only entity with access to a particular design block, so no one but the block owner can adjust version control unless the permission is granted by the owner, via step 214. When the permission is assigned to a specific block and all of its sub-blocks below, the block cannot be utilized until it is completed and until it is checked in. As long as the block is being utilized and used, it is locked and cannot be utilized by any other group member, via step 216.

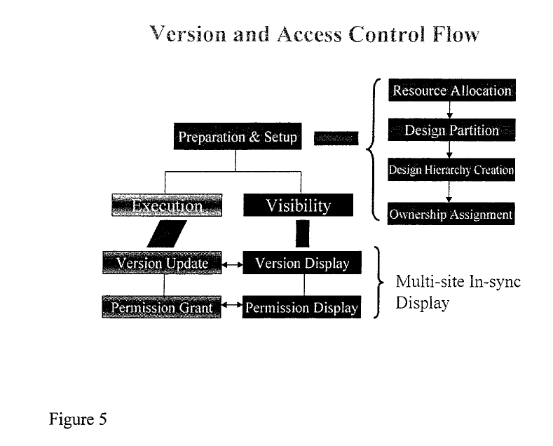

FIG. 5 illustrates an embodiment of a version and access control flow in accordance with the present invention. The in-synch hierarchy display in a preferred embodiment would accommodate the following features as described with respect to FIG. 4.

Design hierarchy set-up

Access control set-up

Design hierarchy control

Display ownership on entire or partial design hierarchy

Display ownership on design block

Display ownership on different design stages

Permission grant on entire or partial design hierarchy

Permission grant on design block

Permission grant on different design stages

Revision control (or configuration) on entire or partial design hierarchy

Revision control on design block

Revision control on different design stages

Dependency control

Project snapshot

Multi-site design synchronization

Multi-site revision control (or configuration) on entire or partial design hierarchy

Multi-site revision control on design block

Multi-site revision control on different design stages such as synthesis and P&R

With all the aforementioned features in place, project managers and designers can then fully control their project status

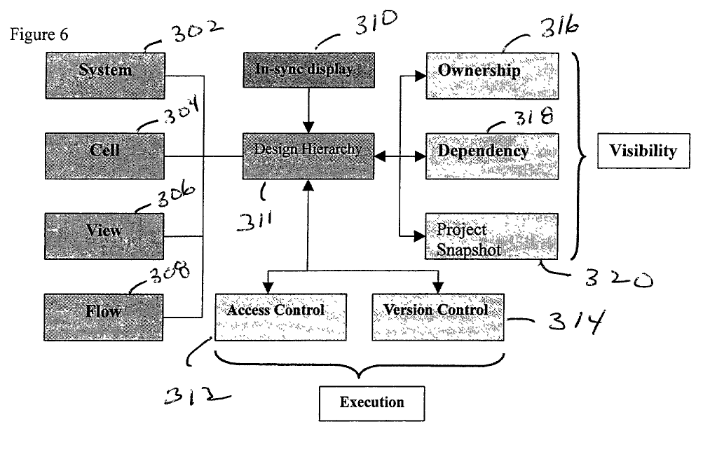

FIG. 6 illustrates the contents of in-sync hierarchy display. The entire design directory structure, including system 302, cell 304, view 306 and flow 308 can be displayed. For the in-sync hierarchy display 310, the primary object is the design hierarchy 311 on the screen. Users can control the version control 312 and access control 314 based upon their access. The system will ensure that there is high visibility on ownership 316, design dependency 318 on all versions on the design hierarchy. A project snapshot 320 and project archive (not shown) in a preferred embodiment is also provided as well.

A system and method in accordance with the present invention provides real-time design synchronization status of various blocks within a design in conjunction with design hierarchy. The status includes all the versions of all of the blocks of a design. The status also provides any incremental design change, and accommodates the design data dependency across the design hierarchy. In addition, all the activities can be synchronized in a single site, multiple groups of single site, and multiple groups of multiple sites.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An integrated circuit chip design system for a design hierarchy, the chip design being provided by a plurality of design blocks, the system comprising:
version and access control which controls the design hierarchy; and
an in-synchronization hierarchy display responsive to the version and access control which illustrates the design hierarchy based upon an ownership of the plurality of design blocks within the hierarchy.

2. The system of the claim 1 wherein the version and access control can be utilized to control the design hierarchy of any combination of the following: an integrated circuit chip, each design block within the chip, each tool view of the chip, and the design flow of the chip.

3. The system of claim 1 wherein an owner of a design block must grant permission for another user to access that design block.

4. The system of claim 3 wherein the permission grant can be utilized to control the design hierarchy of any combination of the following: an integrated circuit chip, each design block within the chip, each tool view of the chip, and the design flow of the chip.

5. The system of claim 1 wherein the ownership assignment can be utilized to control the design hierarchy of any combination of the following: an integrated circuit chip, each design block within the chip, each tool view of the chip, and the design flow of the chip.

6. The system of claim 1 wherein version and access control provides design synchronization.

7. The system of claim 6 wherein the design synchronization can be provided on any combination of a single group, multiple groups on a single site and multiple groups on multiple sites.

8. The system of claim 1 wherein the design hierarchy dependency can be utilized to control any combination of the following: a chip design hierarchy, the flow dependency on entire chip design, the flow dependency on each design block, the tool view dependency within the flow.
